(19) United States
(12) Patent Application Publication
(10) Pub. No.: US 2015/0219266 A1
(43) Pub. Date: Aug. 6, 2015

(54) TUBE FOR REGENERATING PIPELINE

(71) Applicant: KANAFLEX CORPORATION, Osaka (JP)

(72) Inventor: Shigeki Kanao, Hyogo (JP)

(21) Appl. No.: 14/346,467

(22) PCT Filed: Oct. 18, 2013
(86) PCT No.: PCT/JP2013/078337

§ 371 Date: Mar. 21, 2014

(30) Foreign Application Priority Data
Oct. 18, 2012 (JP) 2012-231044

(51) Int. Cl. F16L 55/165

(52) U.S. Cl. CPC F16L 55/1652

(57) ABSTRACT

The present invention provides a tube for regenerating a pipeline which comprises
a lower soft resin layer 5d, which is an inner layer of a linear part 5b of the tube,
an upper soft resin layer 5e formed on an outside of the lower soft resin layer 5d, which is an outer layer of the linear part of the tube, and
a ridge 5c spirally formed on an outer surface of the upper soft resin layer 5e,
   wherein the tube is characterized in that
the ridge 5c is formed from a core 5g made of a hard resin being spirally wound, and a coating 5f for the core, wherein the coating is integrated with the upper soft resin layer 5e while the core is wrapped up in the coating,
the core 5g has a height which is 3.5% to 5% of an inner diameter of the linear part 5b of the tube,
the lower soft resin layer 5d is formed by spiral winding to comprise at least a single layer part 5ds,
the single layer part 5ds has a thickness which is 0.25% to 0.65% of the inner diameter of the linear part 5b of the tube.

The object of the present invention consists in ensuring the desired flattening strength of the tube and inhibiting the tube from the tearing and wrinkling which can be occurred on the tube during the drawing of the tube into the pipe.

### TECHNICAL FIELD

The present invention relates to a tube for regenerating a pipeline. The present tube can be introduced into any pipeline, in order to regenerate the pipeline, such as sewage pipes which had been embedded under the ground and aged.

### BACKGROUND ART

In case of that the load resistance ability and water-stopping ability of the sewage pipe are lowered by the aging of the sewage pipe embedded under the ground for a long time, problems such as collapse of the road and insufficient flowability of the pipe are arising.

To solve these problems, a method for repairing a drainage pipe is suggested and carried out, wherein the pipe such as the aged sewage pipe itself is employed as a supporting body, and a new resin pipe is inserted or created therein as a new drainage pipe.

Among various methods for repairing the drainage pipes, for example, there is a method for creating a pipe therein, which comprises supplying a strip of a hard vinyl chloride material into a manhole, and introducing the strip into the existing pipe while the strip of the hard vinyl chloride material is formed into a tubular form (i.e., as a hard vinyl chloride pipe), by a pipe making machine, at the entrance area of the existing pipe.

In addition, a method, which is called as a pipe connecting method, is also known. This method comprises supplying short pipes into a manhole, instead of the strip of the hard vinyl chloride material, each of which has a diameter smaller than that of the existing pipe and a length smaller than that of the existing pipe, and inserting the short pipes into the existing pipe while the short pipes are connected each other in order.

Herein, the method for creating the pipe requires specific construction equipment such as the pipe making machine, and the creation of the pipe needs skilled workers. On the other hand, the pipe connecting method needs no pipe making machine, but the handling of the short pipe which had been previously produced as a pipe having a given large length is not easy in the narrow manhole. In addition, both of these two methods essentially require the connection of the pipes to form a tubular structure in the existing pipe. Therefore, there is a problem that it should take a relatively longer time for working to improve the sealing ability of the connected area of the pipes.

Recently, Patent Document 1 suggests a method comprises unrolling a flexible tube for the regeneration which have a spiral waving, from a rotary drum, inserting the tube into an existing pipe from one side of the pipe in a manhole, and pulling up the tube at the other side of the existing pipe by a winch or the like. This is a construction method which can conveniently form a new pipeline in the existing pipe and requires no specific construction equipment.

### PRIOR ART DOCUMENTS

### Patent Documents

### Patent Document 1: JP 2002-38581 A

### SUMMARY OF INVENTION

### Problems to be Solved by the Invention

However, Patent Document 1 discloses a tube for regeneration, having a compressive strength on itself which is not so high, since the tube has a predominant flexibility. It is convenient in order to insert the tube into the existing pipe through a manhole, and then pull out the progressing terminal of the tube, from the other manhole connected to the former manhole, by a wire and a winch or the like. Therefore, a given strength is applied to the tube for the regeneration by filling up a grout into the space between the existing pipe and the inserted tube for the regeneration as well as the spiral groove on the tube for the regeneration along its whole length and its whole circumference to integrate the tube together with the existing pipe. As a result, there was a defect that the construction period is longer.

Herein, in view of the problems described above with respect to the conventional tubes for the regeneration, subjects of the present invention consist in a provision of a tube for regenerating a pipeline, which can ensure a desired strength (particularly, flattening strength) by itself without filling up of any grout.

As described above, even if the desired flattening strength is ensured on the tube for regenerating a pipeline, tears (containing breakage) may be occurred on the outer circumferential area of the tube for regenerating a pipeline, i.e., outer area of the curved area of the tube for regenerating a pipeline in the bend radius direction, to which tension is applied, during the tube for regenerating a pipeline is drawn into the existing pipe such as a drainage pipe, particularly during the tube for regenerating a pipeline is previously set on a rotary drum by winding, and/or during the tube for regenerating a pipeline is inserted in a curved state and drawn into the existing pipe from a manhole. Herein, even if the tears are not occurred, in case of that the curved tube for regenerating a pipeline is relaxed in a linear state, the elongated outer circumferential area by the curving shrinks and then waves, and wrinkles may be formed on the inner surface and/or the outer surface of the tube. Furthermore, on the inner circumferential area opposite to the outer circumferential area (i.e., the inner area of the curved area of the tube for regenerating a pipeline in the bend radius direction, to which compression force is applied) (particularly on the inner surface of the tube), protruding wrinkles on the inner surface of the tube are easily formed by the shrinking of the inner circumferential area to relax the tension applied to the outer circumferential area. Because an extremely large force up to 5000N is applied to such tube for regenerating a pipeline. As described above, when the tears are occurred on the tube for regenerating a pipeline, problems such as leakage of the liquid flowing in the tube may be arisen. In case of that the protruding wrinkles are formed on the inner surface of the tube for regenerating a pipeline, flatness of the inner surface is disappeared, and problems such as lowering the flowability of the liquid flowing in the tube may be arisen. In addition, in case of that such wrinkles are formed on the tube for regenerating a pipeline, and an additional branch pipe is attached to the tube, the fixation of the branch pipe to the tube may be difficult due to such wrinkles.

Herein, in view of these problems, the important problems to be solved by the present invention consist in inhibition of the tears and wrinkles which may be occur on the tube for regenerating a pipeline during the drawing of the tube, in addition to ensuring the flattening strength of the tube for regenerating the pipeline.

### Means for Solving the Problems

The present invention is a tube for regenerating a pipeline, which comprises

a lower soft resin layer, which is an inner layer of a linear part of the tube,

an upper soft resin layer formed on an outside of the lower soft resin layer, which is an outer layer of the linear part of the tube, and

a ridge spirally formed on an outer surface of the upper soft resin layer,

wherein the tube is characterized in that

the ridge is formed from a core made of a hard resin being spirally wound, and a coating for the core, wherein the coating is integrated with the upper soft resin layer while the core is wrapped up in the coating,

the core has a height which is 3.5% to 5% of an inner diameter of the linear part of the tube,

the lower soft resin layer is formed by spiral winding to comprise at least a single layer part,

the single layer part has a thickness which is 0.25% to 0.65% of the inner diameter of the linear part of the tube.

According to the present invention, the core may have a width which is 80 to 200% of a height of the core.

According to the present invention, the ridge may have a spiral pitch which is 150 to 350% of a height of the core. Herein, the spiral pitch of the ridge corresponds to the spiral pitch of the core. Hereinafter, they can be simply referred to as “pitch”.

According to the present invention, the linear part of the tube may have a thickness which is 0.7 to 1.5% of the inner diameter of the linear part of the tube.

According to the present invention, the core can be formed from a hard resin(s), such as an engineering plastic(s).

More specifically, the core can be formed from any one of PPS (polyphenylene sulfide), PPE (polyphenylene ether), PEI (polyether imide), PAR (polyarylate), PES (polyether sulfone), PEEK (polyetheretherketone), PTFE (polytetrafluoroethylene), PET (polyethylene terephthalate), PBT (polybutylene terephthalate), PA (polyamide), POM (polyacetal) and a polymer blend thereof.

Preferably, the core can be formed from PPS (polyphenylene sulfide) or PPE (polyphenylene ether).

Herein, with respect to the present invention, the terms of “being formed from” (or can be formed from) and “form(ing)” mean that the other component(s) than the main component can be encompassed.

According to the present invention, the core can comprise a glass fiber.

According to the present invention, the lower soft resin layer can comprise at least one selected from the group consisting of a linear low density polyethylene, other low density polyethylene and a medium density polyethylene. The linear low density polyethylene may be employed in case of that oil resistance is required.

According to the present invention, the upper soft resin layer can comprise a thermoplastic elastomer blended with an olefin-based resin.

According to the present invention, the coating for the core is preferably formed from the same material as that of the upper soft resin layer.

### Effects of the Invention

Tube for regenerating a pipeline according to the present invention has an advantage which can ensure the desired strength, more specifically flattening strength, without any grout filing, which is provided by the inserted tube itself for the regeneration.

In addition to the sufficient secure of the desired strength such as flattening strength, according to the tube for regenerating a pipeline of the present invention, the tears (comprising breakage) and wrinkles can be inhibited, which may be occurred on the linear part of the tube during the drawing of the tube for the regeneration into the existing pipe, particularly during the tube for the regeneration previously set on a rotary drum by winding is curved and inserted into the existing pipe through a manhole.

### BRIEF DESCRIPTION OF DRAWINGS

FIG. 1 is a vertical cross sectional view showing the structure of the drainage pipe, to which the tube for regenerating the pipe according to the present invention is applied.

FIG. 2 is an explanatory view showing a method for inserting the tube for the regeneration according to the present invention into the drainage pipe.

FIG. 3 is a front view showing the structure of the tube for the regeneration according to the present invention with partial cutouts.

FIG. 4 is a schematic view showing an example of a method for producing the tube for the regeneration according to the present invention.

FIG. 5 is a magnified view of the part A of FIG. 3.

FIG. 6 is a magnified schematic cross sectional view showing the structure of the linear part of the tube for the regeneration according to the present invention in detail.

FIG. 7 is a graph obtained from the data of the sample of the tube for the regeneration which is prepared in Production Example 1, wherein flattening strength (kN/m) and height of core (H)/inner diameter Di (%) are plotted as the data in the vertical and horizontal axes respectively.

FIG. 8 is a graph obtained from the data of the sample of the tube for the regeneration which is prepared in Production Example 1, wherein flattening strength (kN/m) and width of core (W)/inner diameter Di (%) are plotted as the data in the vertical and horizontal axes respectively.

FIG. 9 is a graph obtained from the data of the sample of the tube for the regeneration which is prepared in Production Example 1, wherein flattening strength (kN/m) and pitch P/inner diameter Di (%) are plotted as the data in the vertical and horizontal axes respectively.

FIG. 10 is a graph obtained from the data of the sample of the tube for the regeneration which is prepared in Production Example 1, wherein flattening strength (kN/m) and area of core (mm²) are plotted as the data in the vertical and horizontal axes respectively.

FIG. 11 is a graph obtained from the data of the sample of the tube for the regeneration which is prepared in Production Example 1, wherein flattening strength (kN/m) and width of core (W)/height of core (H) (%) are plotted as the data in the vertical and horizontal axes respectively.

FIG. 12 is a graph obtained from the data of the sample of the tube for the regeneration which is prepared in Production Example 1, wherein flattening strength (kN/m) and pitch (P)/height of core (H) (%) are plotted as the data in the vertical and horizontal axes respectively.

FIG. 13 is a graph obtained from the data of the sample of the tube for the regeneration which is prepared in Production Example 2, wherein flattening strength (kN/m) and height of core (H)/inner diameter (Di) (%) are plotted as the data in the vertical and horizontal axes respectively.

FIG. 14 is a graph obtained from the data of the sample of the tube for the regeneration which is prepared in Production Example 2, wherein tensile strength (N/10 mm), and thickness (T₂ₛ) of the single layer part contained in the lower soft resin layer of the linear part of the tube/inner diameter (Di) (%) are plotted as the data in the vertical and horizontal axes respectively.

FIG. 15 is a graph obtained from the data of the sample of the tube for the regeneration which is prepared in Production Example 3, wherein tensile strength (N/10 mm), and thickness (T₂ₛ) of the single layer part contained in the lower soft resin layer of the linear part of the tube/inner diameter (Di) (%) are plotted as the data in the vertical and horizontal axes respectively.

FIG. 16 is a graph obtained from the data of the samples of the tubes for the regeneration which are prepared in Production Examples 2 and 3, wherein tensile strength (N/10 mm), and thickness (T₂ₛ) of the single layer part contained in the lower soft resin layer of the linear part of the tube/inner diameter (Di) (%) are plotted as the data in the vertical and horizontal axes respectively, which is accompanied by the results of 90° bending test.

### DESCRIPTION OF EMBODIMENTS

Hereinafter, the present invention is described in detail according to the embodiment illustrated in the figures.

### 1. Structure of Drainage Pipe

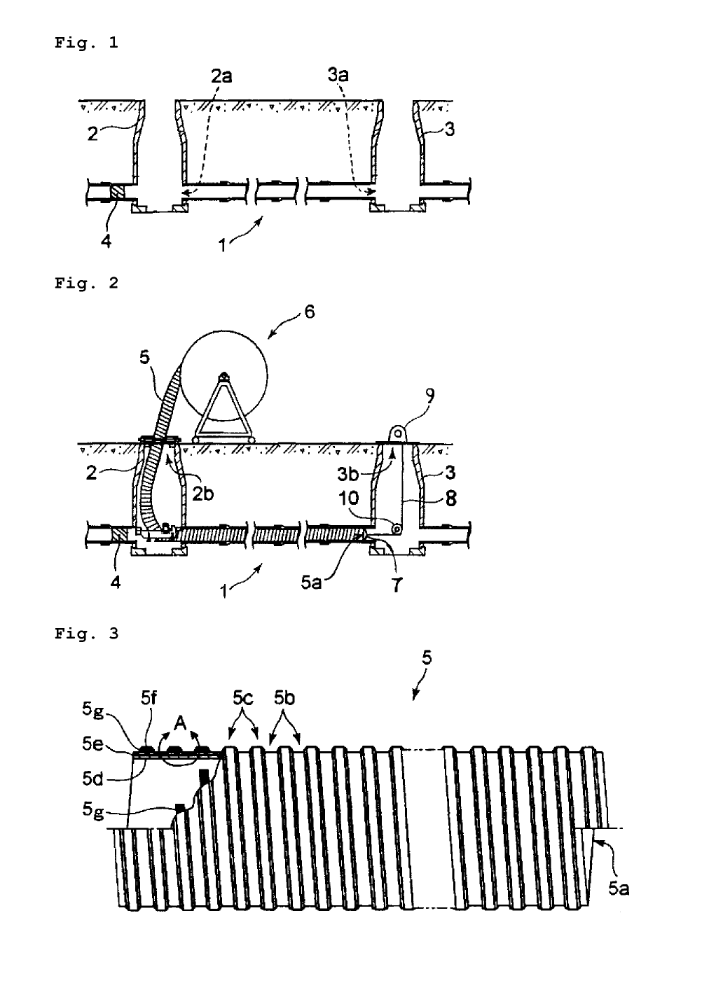

FIG. 1 illustrates an example of the structure of the existing drainage pipes and manholes, to which the tube for regenerating the pipeline according to the present invention is applied (hereinafter, which is also referred to as “tube for the regeneration” in an abbreviation).

A plurality of the existing drainage pipes 1 to be embedded under the ground as shown in the figure is mainly made of concrete. For example, one of the drainage pipes 1 is connected to an aperture 2a provided at the bottom area of a left side manhole 2, and the other is connected to an aperture 3a provided at the bottom area of a right side manhole 3, both of which are placed in a water-draining route.

Upon regenerating these drainage pipes 1, the drainage pipes 1 are previously inspected, wherein the absence of any problems regarding the insertion of the tube for the regeneration therein is confirmed. The drainage pipes 1 are optionally washed. In this case, a water-stopping plug 4 is applied to a drainage pipe.

### 2. Method for Insertion of the Tube for Regeneration

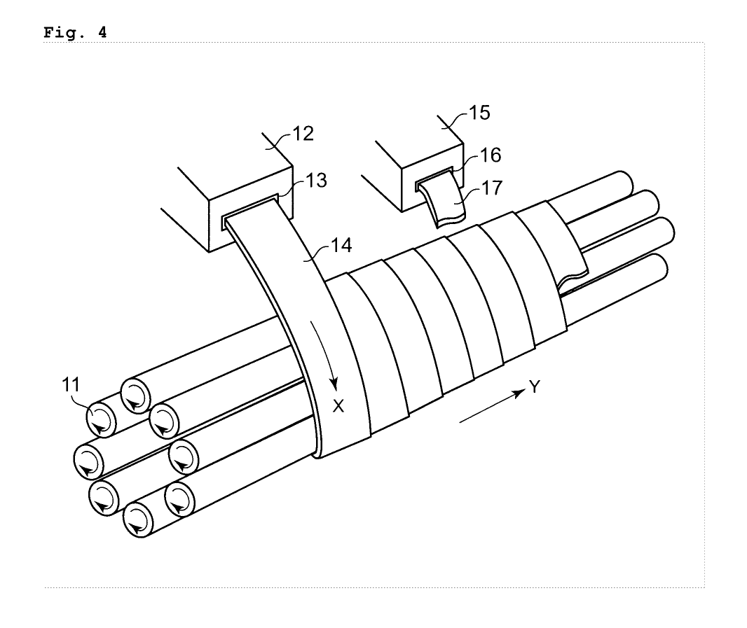

FIG. 2 illustrates a method for inserting the tube for the regeneration according to the present invention into these drainage pipes 1.

Among drainage pipes 1, a drainage pipe 1 at one end is attached to a left side manhole 2, and a drainage pipe 1 at the other end is attached to a right side manhole 3. In such drainage pipe structure, near the one of manholes, or near an upper opening 2b of the left side manhole 2 in the present embodiment, a rotary drum 6 is placed, to which the tube 5 for the regeneration had been wound and set.

Herein, according to the present invention, tears and wrinkles on the tube can be inhibited. The tears on the outer circumferential area of the tube 5 for the regeneration (i.e., on the outer area of the curved area of the tube 5 for the regeneration, which had been wound and set on the rotary drum 6, in the bend radius direction, to which tension is applied) (particularly the tears on the lower soft resin layer which is an inner layer contained in the linear part of the tube 5 for the regeneration in the outer circumferential area, which had been wound and set on the rotary drum 6) during winding and setting the tube 5 for the regeneration on the rotary drum 6 can be inhibited. The wrinkles particularly on the lower soft resin layer which is an inner layer contained in the linear part of the tube 5 for the regeneration in the inner circumferential area, which had been wound and set on the rotary drum 6 (i.e., in the inner area of the curved area of the tube 5 for the regeneration wound and set on the rotary drum 6 in the bend radius direction, to which compression force is applied) can be inhibited. Among others, such wrinkles include protruding wrinkles in convex forms which are formed on the inner surface of the tube. Specifically, protruding wrinkles in convex forms which are formed between the adjacent ridges 5c on the inner surface of the tube can be inhibited. Herein, the tube 5 for the regeneration is generally stored, in a state of that the tube 5 had been wound and set on the rotary drum 6, before use of it. Therefore, if the conformation of the tube is fixed while the wrinkles are formed in the inner surface of the tube, flatness of the inner surface of the tube will disappear, and the flowability may be lowered. Accordingly, inhibition of the formation of such wrinkles is significantly important.

Before drawing of the tube 5 for the regeneration, a cap 7 for the drawing is previously attached to the progressing terminal of the tube 5 for the regeneration. A wire 8 is connected to the cap 7, wherein the wire 8 is drawn through a manhole at the other side, or the right side manhole 3 according to the present embodiment. The wire 8 can be rolled up via a pulley 10 by a driving winch 9 placed near the upper opening 3b of the right side manhole 3.

Accordingly, the tube 5 for the regeneration rewound from the rotary drum 6 can be inserted into the left side manhole 2 through the upper opening 2b, and curved at an angle of about 90° or more, and then introduced into the drainage pipe 1.

Herein, according to the present invention, the tears on the outer circumferential area of the linear part of the tube 5 for the regeneration curved in the manhole 2 (i.e., on the outer area of the curved tube 5 for the regeneration in the bend radius direction, to which tension is applied) (particularly, the tears on the lower soft resin layer which is an inner layer of the linear part of the tube), and the tears on the linear part of the tube 5 for the regeneration during the tube 5 for the regeneration is pulled in the drainage pipe 1 by the wire 8 with the winch 9 (particularly, the tears on the lower soft resin layer which is an inner layer of the linear part of the tube), as well as breakage of the linear part of the tube can be inhibited. Herein, during the drawing of the tube 5 for the regeneration into the drainage pipe 1, the inhibition of the tears on the linear part of the tube 5 for the regeneration is significantly important, since such drawing of the tube 5 for the regeneration into the drainage pipe 1 requires an extremely large force of up to 5000N.

Furthermore, according to the present invention, the formation of the wrinkles on the inner circumferential area of the linear part of the tube 5 for the regeneration which is curved in the manhole 2 (i.e., in the inner area of the curved tube 5 for the regeneration in the bend radius direction, to which compression force is applied) (particularly, the formation of the wrinkles on the lower soft resin layer which is an inner layer of the linear part of the tube 5 for the regeneration in the inner circumferential area, particularly, the formation of the protruding wrinkles in convex forms to the inside direction of the tube which is formed on the inner surface of the tube, specifically, protruding wrinkles in convex forms which are formed between the adjacent ridges 5c on the inner surface of the tube) can be inhibited.

Herein, a method which comprises pushing the rewound tube 5 for the regeneration into the drainage pipe 1, and then introducing the tube 5 into the drainage pipe 1 in order can be employed, which does not use any wire 8.

### 3. Structure of Tube for Regeneration

FIG. 3 is a front view illustrating the structure of the tube 5 for the regeneration.

As shown in the figure, the tube 5 for the regeneration comprises a linear part 5b, and a ridge 5c which is spirally formed on the outer surface of the linear part 5b.

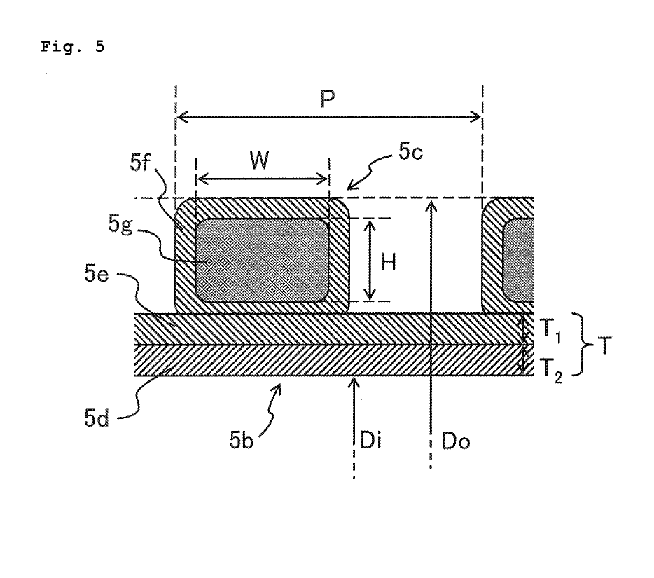

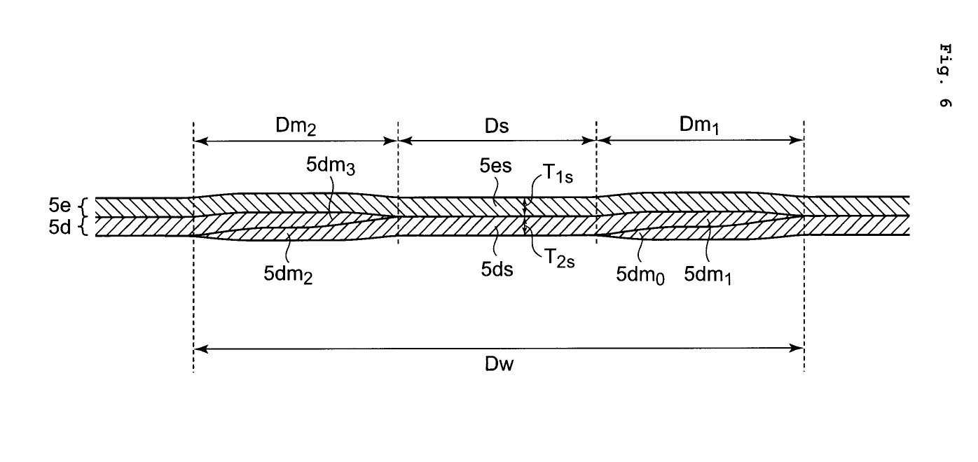

The linear part 5b can be formed from a lower soft resin layer (or an inner layer) 5d, and an upper soft resin layer (or an outer layer) 5e (see particularly FIG. 5). The ridge 5c is spirally wound and formed on the outer surface of the upper soft resin layer 5e, wherein the ridge 5c comprises of a core 5g made of a hard resin, and a coating 5f for the core (see particularly FIG. 5).

The above-described tube 5 for the regeneration can be prepared by a method which does not limit the present invention, for example, comprising
extruding a soft resin (or a soft resin composition) for the inner layer and a soft resin (or a soft resin composition) for the outer layer respectively in a form of a strip in a melt or soften state,
spirally winding these strips around approximately cylindrical roller in order to form a lower soft resin layer 5d and an upper soft resin layer 5e respectively, wherein the edge of each strip is at least overlapping, in order,
additionally, extruding a hard resin (or a hard resin composition) as a rod in a melt or soften state to form a core 5g,
wrapping a resin around the rod to form a coating 5f for the core, which results in a ridge 5c, and
spirally winding the ridge 5c on the outer surface of the upper soft resin layer 5e (in other words, on the outer surface of the linear part 5b of the tube) at a given pitch.

More specifically, as shown in FIG. 4, a plurality of rolls 11 is initially appropriately arranged on an approximately concentric circle to form an approximately cylindrical roller. While each roll is rotated respectively, a soft resin (or a soft resin composition) for the inner layer in a melt or soften state is extruded from a lip 13 of a die 12 in a direction of the allow X (i.e., in an approximately perpendicular direction relative to the longitudinal direction Y of the roll 11) to form a soft resin strip 14 for the inner layer, and the strip 14 is spirally wound on the roller to form an inner layer such that the edge of the strip is overlapping in order. Herein, an appropriate rotation of a plurality of rolls 11 forwards the resulting inner layer in a direction along the allow Y in order. The each roll 11 may comprise a heating means and/or a cooling means.

According to the present invention, it is important that the edge of the strip 14 is overlapping in order while the strip 14 is spirally wound such that the resulting inner layer contains a single layer part (see FIG. 6: single layer part 5ds, etc.), which is described hereinafter. In other words, in the present invention, it is important that the middle part of the strip 14 is spirally wound as a single layer without overlapping, at the middle part of the strip 14, with the strip which has been previously spirally wound.

Then, a soft resin (or a soft resin composition) for the outer layer in a melt or soften state is extruded form a lip 16 of a die 15 formed next to the die 12 to form a soft resin strip 17 for the outer layer. The outer layer is formed on the inner layer such that the strip 17 covers the above-described inner layer. Preferably, the strip 17 is spirally wound while the edge of the strip 17 is overlapped in order.

Herein, according to the present invention, even if the outer layer is formed by such spiral winding, the outer layer may have an approximately uniform thickness due to the melting, fusing or adhering of the strip 17, and the like (see FIG. 6, etc.).

Finally, the core 5g with the wrapping of the coating 5f (see particularly FIG. 5) can be spirally wound on the upper surface of the outer layer which has been formed as described above (in other words, on the outer surface of the linear part 5b of the tube) at a given pitch to form the ridge 5c. Herein, for example, the core 5g with the wrapping of the coating 5f can be formed with a double die (or a double nozzle). Specifically, the core 5g and the coating 5f for the core can be almost simultaneously formed by extruding a hard resin (or a hard resin composition) in a melt or soften state via an inner die of the double die to form the core, while a material in a melt or soften state is extruded via an outer die of the double die to form the coating for the core. The formation of the core 5g with the wrapping of the coating 5f by such extrusion can provide advantages that the arrangement and positioning of the ridge on the outer layer as well as adjustment of the pitch are facilitated.

Exterior of the tube 5 for the regeneration may be resemble to the conventionally known corrugate pipe. However, the tube 5 for the regeneration according to the present invention has specifically determined dimensions thereof or ratios of the dimensions of the components, which are described hereinafter in detail with referring to FIG. 5. According to the tube 5 for the regeneration of the present invention, there is no need to fill any grout into the space between the existing pipe and the tube for the regeneration as well as the spiral grove of the tube for the regeneration along its entire length and its whole circumference, which is required in the invention of Patent Document 1. Therefore, in the present invention, it is enough to attach a grout material only around the entrance of the tube 5 for the regeneration.

Herein, as described with respect to FIG. 5, which illustrates a magnified Part A of FIG. 3, the outer diameter (Do) of the tube 5 for the regeneration can be determined in consideration of the workability for the drawing of the tube. It depends on the inner diameter of the drainage pipe, into which the tube 5 for the regeneration is to be inserted. On the other hand, the inner diameter (Di) of the linear part 5b of the tube is preferably close as much as possible to the inner diameter of the drainage pipe, into which the tube 5 for the regeneration is to be inserted, in order to ensure sufficient water-drain flow. For example, the inner diameter (Di) may be about 170 to 320 mm, while the outer diameter (Do) is about 190 to 345 mm.

### 3.1 Linear Part of Tube

It is desirable that the linear part 5b of the tube has a flexibility (or stretchability) allowing the tube 5 for the regeneration to correspond to its entire curving, and a suitable tensile strength so as to provide no tears during the drawing of the tube, such that the tube 5 for the regeneration is to be appropriate to be bent and drawn into the drainage pipe (e.g., as shown in FIG. 1, the pipe 5 is existing at an angle of about 90° relative to the longitudinal axis of the manhole 2 at the lower area thereof).

Particularly, the linear part 5b of the tube for regenerating a pipeline according to the present invention is characterized in that the lower soft resin layer 5d comprises at least one single layer part 5ds, which is described in detail in the magnified view of FIG. 6. As described above, the single layer part 5ds can be formed during the lower soft resin layer 5d is formed by spiral winding.

According to the present invention, the single layer part 5ds contained in the lower soft resin layer 5d has a thickness which is within a range of from 0.25% to 0.65% of the inner diameter of the linear part of the tube, which is described hereinafter in detail. For example, formation of the tears and wrinkles on the linear part of the tube, which may occur during setting of the tube for the regeneration on the rotary drum (see FIG. 2) and during the drawing of the tube for the regeneration, can be significantly inhibited.

### 3.1 (a) Material for Lower Soft Resin Layer

The lower soft resin layer 5d, in FIG. 5, can be formed from a thermoplastic resin having an excellent chemical resistance such as vinyl chloride resin and polyolefin resin; a thermoplastic elastomer such as olefin-based thermoplastic elastomer and styrene-based thermoplastic elastomer; etc. In case of that oil resistance is required, the lower soft resin layer 5d is preferably formed from a material comprising at least one resin selected from the group consisting of a linear low density polyethylene (LLDPE), other low density polyethylene and a medium density polyethylene. The lower soft resin layer 5d may be optionally blended with an olefin-based resin, etc.

The material for forming the lower soft resin layer 5d is not limited to the above-listed material, and preferably selected such that the resulting lower soft resin layer 5d has a tensile strength within a range of from 100 to 650 N/10 mm, which can be determined according to “JIS K 7161 (Plastics-Determination of tensile properties-)”.

### 3.1 (b) Material for Upper Soft Resin Layer

The upper soft resin layer 5e, in FIG. 5, can be formed from a thermoplastic resin having an excellent adhering property to the lower soft resin layer 5d and the coating 5f for the core of the ridge 5c (particularly, adhering property in a melt or soften state), preferably thermoplastic resin further having an excellent chemical resistance, such as thermoplastic elastomer (e.g., styrene-based, olefin-based, nylon-based, polyester-based, polyamide-based, or polystyrene-based thermoplastic elastomer), etc. In case of that long-term reliability or weather resistance is further required, it is preferable to employ a hydrogenated styrene-based thermoplastic elastomer, e.g., styrene-ethylene/butylene-styrene block copolymer (SEBS).

In case of that the above-described thermoplastic elastomer is further blended with an olefin-based resin, it gives further preference since properties such as inner pressure (e.g., inner water pressure), outer pressure (e.g., outer water pressure), flattening strength, compression strength, tensile strength can be intended to be improved.

Herein, the above-described SEBS may comprise acid-modified or amine-modified SEBS. The above-described olefin-based resin comprises polypropylene (PP), polyethylene (PE), etc.

According to the present invention, the material for forming the upper soft resin layer 5e is not limited to the above-listed material, preferably selected such that the upper soft resin layer 5e has a tensile strength within a range of from 30 to 150 N/10 mm, which can be determined according to “JIS K 7161”. Herein, the tensile strength of the upper soft resin layer 5e is smaller than that of the lower soft resin layer 5d.

### 3.1 (c) Thickness of Linear Part of Tube

As shown in the schematic view of FIG. 5, thickness T of the linear part 5b of the tube is a total of thickness T₁ of the upper soft resin layer 5e and thickness T₂ of the lower soft resin layer 5d. Thickness T can be appropriately determined in consideration of the materials for the upper soft resin layer 5e and the lower soft resin layer 5d, and the processability during the formation of the tube, etc., such that an appropriate flexibility (or streatchability) and tensile strength can be obtained in the whole linear part 5b of the tube. It is preferable that the linear part 5b of the tube has thickness T which is about 0.7% or more of the inner diameter Di of the linear part of the tube to ensure an appropriate tensile strength. The upper limit of the thickness T of the linear part 5b of the tube may be, for example, about 1.5% or less of the inner diameter Di of the linear part 5b of the tube, which may be limited by the inner diameter of the drainage pipe into which the tube 5 for the regeneration is to be inserted. The thickness T of the linear part 5b of the tube may be representatively about 1 to 5 mm. The ratio between the thickness T₁ of the upper soft resin layer 5e and the thickness T₂ of the lower soft resin layer 5d can be appropriately determined.

Herein, according to the present invention, thickness T of the linear part 5b of the tube, and thickness T₁ of the upper soft resin layer 5e and thickness T₂ of the lower soft resin layer 5d are respectively mean an average of the maximum and the minimum among the actual measurements at a plurality of locations.

Herein, the lower soft resin layer 5d of the linear part 5b of the tube is a layer which is formed by spiral winding of the strip (see FIG. 4). Thus, as exemplarily shown in the magnified view of FIG. 6 in detail, the lower soft resin layer 5d comprises at least one single layer part 5ds (i.e., a part without any overlapping of the strip) and overlapping parts 5dm₁ and 5dm₂ which are placed on the both sides of the single layer part. Herein, the overlapping part 5dm₁ means a part which overlaps with the overlapping part 5dm₀ which has been formed from the edge of the strip previously placed. The overlapping part 5dm₂ means a part which overlaps with the overlapping part 5dm₃ which is to be formed from the edge of the strip placed thereafter. Herein, in the FIG. 5, thickness of the lower soft resin layer 5d and thickness of the upper soft resin layer 5e are respectively shown in an approximately uniform thickness for the sake of the convenient description. In FIG. 6, thickness of the upper soft resin layer 5e is shown in an approximately uniform thickness for the sake of the convenient description. In FIG. 6, the ridge 5c is not shown for the sake of the convenient description. The ridge 5c may be placed on the upper side of the single layer part, on the upper side of the overlapping part, or over both of the upper side of the single layer part and the overlapping part(s).

According to the present invention, such single layer part 5ds contained in the lower soft resin layer 5d of the linear part 5b of the tube can inhibit the breakage and the tears of the lower soft resin layer 5d and the formation of the wrinkles on the bent or curved area of the tube. Because the single layer part 5ds absorbs the curving energy on the tube and/or stretches upon the tube for the regeneration is drawn into a pipe such as a drainage pipe via a manhole (e.g., see FIG. 1 and FIG. 2), particularly upon setting the tube for the regeneration on a rotary drum by winding it and getting the tube ready to be drawn, and upon inserting the tube into the drainage pipe from the manhole, which is curved at an angle (or 90° or more) or approximately perpendicular to the manhole, or upon pulling the tube for the regeneration through the drainage pipe. Accordingly, the single layer part 5ds may have ability to spread and relax the force applied to the lower soft resin layer 5d. On the other hand, the overlapping parts can provide an appropriate flattening strength to the tube for the regeneration, since the overlapped area has a larger thickness than that of the single layer part, and the overlapping part can be spirally arranged.

As shown in FIG. 6, in the single layer part 5ds of the lower soft resin layer 5d, the single layer part 5ds has thickness T₂ₛ which is within a range of from 0.25% to 0.65%, preferably from 0.3% to 0.65%, more preferably from 0.35% to 0.65% of the inner diameter Di of the linear part 5b of the tube (see FIG. 5), which is described hereinafter in detail.

Herein, the inner diameter Di of the linear part 5b of the tube means an average of the maximum and the minimum among the actual measurements of the inner diameter at a plurality of locations.

When the ratio of T₂ₛ/Di is less than 0.25%, the tensile strength is decreased, the tears or cracks may be easily occurred on the linear part of the tube (particularly on the lower soft resin layer which forms the inner layer of the linear part of the tube), and sometimes breakage of the tube may be occurred. When the ratio of T₂ₛ/Di is more than 0.65%, the tensile strength is increased, but wrinkles may be easily formed on the linear part of the tube (particularly on the lower soft resin layer which forms the inner layer of the linear part of the tube) upon the tube is curved, and sometimes flexibility or flowability of the tube for the regeneration may be decreased.

Thus, according to the present invention, setting the ratio of T₂ₛ/Di (%) within the above-described range can inhibit the tears which may occur on the outer circumferential area of the linear part of the tube for the regeneration (and/or the wrinkles which may occur when the stretched outer circumferential area is returned as it is) as well as the wrinkles which may occur on the inner circumferential area of the linear part of the tube for the regeneration.

In addition, according to the present invention, setting the ratio of T₂ₛ/Di within the above-described range can provide a tensile strength which is no less than 100N/10 mm to the tube for the regeneration.

Herein, with respect to the linear part 5b of the tube, the single layer part 5ds has thickness T₂ₛ which is within a range of from 30 to 70%, preferably from 33 to 67% of the thickness of the linear part of the tube, which is a total thickness (T₂ₛ+T₂ₛ) wherein T₂ₛ is the thickness of the single layer part 5ds, and T₁ₛ is a thickness of the upper soft resin layer 5es which is placed on the upper side of the single layer part. The ratio of T₂ₛ/(T₂ₛ+T₂ₛ) (%) within the above-described range can inhibit the formation of the tears and wrinkles on the linear part of the tube for regenerating a pipeline (particularly on the single layer part 5ds of the lower soft resin layer 5d).

Herein, as shown in FIG. 6, the thickness T₂ₛ of the single layer part, and the thickness T₁ₛ of the upper soft resin layer 5es, which is placed on the upper side of the single layer part, are respectively mean an average of the maximum and the minimum among the measurements at a plurality of locations.

T₁ₛ is specifically within a range of from 0.1 to 4 mm, and T₂ₛ is specifically within a range of from 0.1 to 2 mm.

Herein, the single layer part 5ds has width Ds (which is a width along the longitudinal direction of the tube for regenerating a pipeline according to the present invention) which is generally within a range of from 20 to 50%, preferably from 25 to 45% of the total width Dw (Ds+Dm₂+Dm₂) wherein Ds is a width of the single layer part 5ds, and Dm₂ is a width of the overlapping part 5dm₂ and Dm₂ is a width of the overlapping part 5dm₂, wherein the single layer part 5ds is present between the overlapping parts 5dm₂ and 5dm₂. Ratio of Ds/Dw (%) within the above-described range gives a tendency to reduce the occurrence of the tears and wrinkles on the linear part of the tube for the regeneration (particularly, on the single layer part 5ds of the lower soft resin layer).

As described above, according to the present invention, setting the ratios of T₂ₛ/Di, T₂ₛ/(T₁ₛ+T₂ₛ) and Ds/Dw, particularly the ratio of T₂ₛ/Di within the above-described range can inhibit the formation of the tears or wrinkles on the linear part of the tube. Furthermore, synergistic effects together with the strength such as the desired flattening strength which can be added by the ridge allow the tube for regenerating a pipeline to have an excellent drawing ability which is not asserted by the prior arts, which is described hereinafter in detail.

### 3.2 Ridge

Principally, the ridge 5c shown in FIG. 5 plays a role to improve the strength, particularly flattening strength on the tube 5 for the regeneration. Therefore, the tube 5 does not require any grout filling, and the tube 5 for the regeneration itself can have a sufficient strength, particularly flattening strength, wherein the tube 5 for the regeneration can support itself. Herein, it is required for the ridge 5c to withstand the drawing of the tube 5 for the regeneration which is bent into the drainage pipe, and not to hinder the drawing.

### 3.2 (a) Material for Coating for Core

The coating 5f for the core is formed from a material having the same or similar property to that of the material for the upper soft resin layer 5e which is described above. The material can be formed into a tubular form during the production of the tube 5 for the regeneration, and integrated with the upper soft resin layer 5e by heat fusion during the spiral winding of it on the outer surface of the upper soft resin layer 5e.

### 3.2 (b) Material for Core

The core 5g is formed from a hard resin (or a hard resin composition). The hard resin can comprise a known resin as the engineering plastic. Example of the hard resin comprises any one of PPS (polyphenylene sulfide), PPE (polyphenylene ether), PEI (polyether imide), PAR (polyarylate), PES (polyether sulfone), PEEK (polyetheretherketone), PTFE (polytetrafluoroethylene), PET (polyethylene terephthalate), PBT (polybutylene terephthalate), PA (polyamide), POM (polyacetal), PP (polypropylene), and any other saturated polyester than those described above, and a polymer blend thereof.

PPS and PPE which are examples described above are engineering plastics having greater heat-resistance, which have high heat resisting property, strength and rigidity, and an excellent dimensional stability as well as excellent formability and processibility as thermoplastic resins. Conventionally, PPS and PPE are employed as alternatives of the metals and thermosetting resins. PPS and PPE are often processed by injection molding. Whereas, according to the present invention, they can be employed as materials for the core in the tube for regenerating a drainage pipe. They can be processed by an extrusion molding, which does not limit the present invention.

The core 5g is formed from PPS or PPE has an extremely lowered water absorption, a small dimensional variation by the absorption of water, and an excellent dimensional stability. Such core 5g further has an excellent hot water resistance.

PPS may be a linear type or a cross-linked type. Use of the linear type can provide an elasticity to the core.

PPE may be a modified-PPE (m-PPE), which may further comprise a resin such as a styrene-based resin such as PS (polystyrene) having an excellent formability, PA (polyamide) and PP (polypropylene).

The hard resin for forming the core 5g may be reinforced. A reinforcing/filling agent such as glass fiber, carbon fiber, aramid fiber, potassium titanate whisker, talc, mica, calcium carbonate, carbon black, hydrous calcium silicate, magnesium carbonate may be added to the resin material which is exemplarily described above.

Content of the reinforcing/filling agent to be added to the core 5g is not particularly limited, but it is generally within a range of from 0.1 wt. % to 50 wt. %, for example from 20 wt. % to 50 wt. %, or from 30 wt. % to 50 wt. % relative to the total weight of the core.

In addition to the hard resin exemplarily described above, the example of the hard resin for forming the core 5g comprises PC (polycarbonate), aromatic nylon, PS (polystyrene), ABS resin, unsaturated polyester, and polymer blend material containing analogs of the above described polymers.

Optionally, the hard resin for forming the core 5g may further comprise other resin component such as elastomer.

### 3.2 (c) Configuration and Dimension of Ridge, Etc.

The ridge 5c can be formed as follows. The hard resin is extruded in a form of a rod to from the core 5g. Thereafter/simultaneously to the previous step, while the coating 5f for the core is shaped into a tubular form, the core 5g is wrapped up in the resulting tubular form. The resulting core 5g wrapped up in the coating 5f is spirally wound on the outer surface of the linear part 5b of the tube. Adhesion between the core 5g and the coating 5f for the core may not be always strong, since the thermal properties are different each other. However, the core 5g can be substantially integrated with the coating 5f for the core, since whole surface of the core 5g is wrapped up in the coating 5f.

Referring to FIG. 5, the height H of the core 5g means the maximum dimension, in a direction perpendicular to the central longitudinal axis of the linear part 5b of the tube, in the cross sectional view of the linear part 5b of the tube in a plane containing the central longitudinal axis of the linear part 5b of the tube (see also FIG. 3). Width W of the core 5g means the maximum dimension, in a direction parallel to the central longitudinal axis of the linear part 5b of the tube, in the cross-sectional view of the linear part 5b of the tube. The cross-section of the core 5g may have an approximately tetragonal form (containing square, rectangle, trapezoid, and the like, wherein the corner(s) may be rounded). Pitch P of the ridge 5c means a length of the repeating unit of the ridge 5c in the cross section. Referring to FIG. 5, pitch P is exemplarily represented as a distance between the left side edge of one ridge 5c and the left side edge of the other adjacent ridge 5c. However, it is not limited to this distance.

There may be various factors which may affect the flattening strength of the tube 5 for the regeneration, such as height (H), width (W) and area of the core 5g; pitch (P) of the ridge 5c; thickness (T) and inner diameter (Di) of the linear part 5b of the tube, etc. Herein, as results of the researches by the present inventor, it is found that the flattening strength of the tube 5 for the regeneration correlates, at an extremely high degree, to the height (H) of the core 5g (as a ratio of the height (H) of the core 5g relative to the inner diameter (Di) of the linear part 5b of the tube), which is described hereinafter in the examples. There is a tendency that a higher flattening strength is obtained at a higher ratio of the height (H) of the core 5g relative to the inner diameter (Di) of the linear part 5b of the tube. According to the present invention, in case of the height (H) of the core 5g is about 3.5% or more of the inner diameter (Di) of the linear part 5b of the tube, a flattening strength at a higher degree sufficient to allow the tube 5 for the regeneration to support itself, i.e., a flattening strength equal to, or more than, that of the hard vinyl chloride pipe can be ensured. For example, the upper limit of the height (H) of the core 5g may be about 5% or less of the inner diameter (Di) of the linear part 5b of the tube. It may be limited by the inner diameter of the drainage pipe into which the tube 5 for the regeneration is to be inserted, and the bend radius of the tube (which means the minimum radius of the sample of the tube when the sample is curved in U-shape wherein the sample has a sufficient length for the bending test and the adjacent ridges are fully contacting each other). Representatively, the height (H) of the core 5g may be within a range of from about 5.5 to 12 mm.

According to the present invention, the height (H) of the core 5g is preferably within a range of from 3.5% to 5%, more preferably from 3.5% to 4.5% of the inner diameter (Di) of the linear part 5b of the tube.

According to the present invention, setting the height (H) of the core 5g within a range of from 3.5% to 5% of the inner diameter (Di) of the linear part 5b of the tube can provide the above-described desired flattening strength, particularly the flattening strength equal to, or more than, that of the hard vinyl chloride pipe. It can further give a bending angel of 90° or more to the tube for regenerating a pipeline while the tube for the regeneration is reinforced. Furthermore, it can prevent from the tube for regenerating a pipeline from bending over the degree required for the tube wherein the adjacent ridges thereof are contacted each other when the tube is curved. As a result, it can inhibit the formation of the tears and wrinkles on the linear part of the tube for regenerating a pipeline, as well

Herein, the flattening strength of the hard vinyl chloride pipe having a nominal diameter of 200 mm, 250 mm, 300 mm or 350 mm is 4.28 kN/m, 4.61 kN/m, 5.52 kN/m or 6.17 kN/m, respectively.

In the present invention, the term “nominal diameter” means an outer diameter of the tube for the regeneration which fits with the inner diameter of the desired pipeline to be regenerated. For example, the tube for the regeneration having the nominal diameter of 200 mm means the tube for the regeneration having the outer diameter fits with the pipeline to be regenerated having an inner diameter of 200 mm.

More specifically, the tube for the regeneration of the nominal diameter of 200 mm has the outer diameter (Do), for example, within a range of from 190 to 197 mm.

The tube for the regeneration of the nominal diameter of 250 mm has the outer diameter (Do), for example, within a range of from 233 to 240 mm.

The tube for the regeneration of the nominal diameter of 300 mm has the outer diameter (Do), for example, within a range of from 286 to 293 mm.

The tube for the regeneration of the nominal diameter of 350 mm has the outer diameter (Do), for example, within a range of from 341 to 348 mm.

In case of the tube for the regeneration has the nominal diameter of 200 mm, the tube has a flattening strength of no less than 4.28 kN/m, preferably within a range of from 4.28 to 7 kN/m.

In case of the tube for the regeneration has the nominal diameter of 250 mm, the tube has a flattening strength of no less than 4.61 kN/m, preferably within a range of from 4.61 to 8 kN/m.

In case of the tube for the regeneration has the nominal diameter of 300 mm, the tube has a flattening strength of no less than 5.52 kN/m, preferably within a range of from 5.52 to 9 kN/m.

In case of the tube for the regeneration has the nominal diameter of 350 mm, the tube has a flattening strength of no less than 6.17 kN/m, preferably within a range of from 6.17 to 10 kN/m.

For example, the width W of the core 5g may be within a range of from 80 to 200% of the height H of the core 5g. Although the width W of the core 5g has a smaller influence on the flattening strength (or a smaller correlation to) than that of the height H of the core 5g, if the width W is too small relative to the height H, the flattening strength may be decreased. Setting of the width W to 80% or more of the height H can maintain the correlation at a high degree between the flattening strength and the height H (relative to the inner diameter Di). On the other hand, while it is considered that a higher width W of the core 5g can give a higher flattening strength, there is a tendency that the tube 5 for the regeneration is not easily curved and the bend radius may be larger. Setting the width W to 200% or less of the height H, a smaller bend radius can be obtained, and the tube 5 for the regeneration can be readily bent. The width W of the core 5g can be representatively within a range of from about 4 mm to about 24 mm, preferably from about 7 mm to about 15 mm.

For example, the pitch P of the ridge 5c may be within a range of from 150 to 350% of the height H of the core 5g. Although the pitch P of the ridge 5c has a smaller influence on the flattening strength than (or a smaller correlation to) that of the height H of the core 5g, the flattening strength may be decreased in case of the pitch P is too large to the height H. The pitch P of 350% or less of the height H can maintain the correlation at a high degree between the flattening strength and the height H (relative to the inner diameter Di). On the other hand, while it is considered that a smaller pitch P of the ridge 5c can give a higher flattening strength, there is a tendency that the tube 5 for the regeneration can not be easily curved, and the bend radius described above may be larger. When the pitch P is set to 150% or more of the height H, a smaller bend radius can be obtained, and the tube 5 for the regeneration can be readily bent. The pitch P of the ridge 5c may be representatively within a range of from about 8 mm to about 42 mm, preferably from about 9 mm to about 30 mm.

One embodiment of the tube for the regeneration according to the present invention is described above. According to the present embodiment of the tube 5 for the regeneration, the ridge comprises the core made of the hard resin, and the height H of the core 5g is 3.5% or more, preferably within a range of from 3.5% to 5%, more preferably from 3.5% to 4.5% of the inner diameter Di of the linear part 5b of the tube. Therefore, the tube 5 for the regeneration has a necessary rigidity which can ensure a flattening strength at a high degree sufficient to allow the tube 5 for the regeneration support itself, preferably a high flattening strength same or more to that of the hard vinyl chloride pipe.

Thus, the tube 5 for the regeneration has such improved flattening strength. Accordingly, if such tube 5 is inserted into the existing drainage pipe 1 (FIG. 2), there is no need to fill any grout into the space between the tube 5 and the drainage pipe 1 as well as the spiral groove of the tube 5 for the regeneration along its whole length and its whole circumference. Therefore, only such tube 5 for the regeneration can create a new drainage pipe in the existing drainage pipe.

According to the embodiment of the present tube 5 for the regeneration, the tube 5 for the regeneration, wherein the linear part 5b of the tube is formed from a soft resin layer, can be curved at a necessary and sufficient curvature, during rewinding the tube 5 from the rotary drum and inserting it into the manhole 2, and then continuously inserting the tube 5 into the drainage pipe 1 from the inside of the manhole 2, and therefore, the execution of the work can be conveniently carried out.

Particularly, according to the present invention, the lower soft resin layer 5d of the linear part 5b of the tube has the single layer part 5ds, and the thickness T₂ₛ thereof is set within a range from 0.25% to 0.65%, preferably from 0.3% to 0.65%, more preferably from 0.35% to 0.65% relative to the inner diameter Di. Therefore, it can give an appropriate tensile strength of no less than 100 N/10 mm, and significantly inhibit the tears and wrinkles on the linear part of the tube for the regeneration during winding the tube for the regeneration on the rotary drum and/or during curving the tube for the regeneration at an angle of 90° or more in the manhole and inserting it into the drainage pipe.

Herein, the coating 5f for the core 5g made of the hard resin wherein the core 5g is wrapped up in the coating 5f has been formed from a material same as that of the upper soft resin layer 5e or a material having a similar thermal behavior to that of the upper soft resin layer 5e. Therefore, the coating 5f can be integrated with the upper soft resin layer 5e. Accordingly, the core 5g made of the hard resin can be surely wound around the outer surface of the linear part 5b of the tube 5 for the regeneration wherein the coating 5f can be integrated with the linear part 5b of the tube.

### EXAMPLES

Samples of the tube for regenerating a pipeline were prepared as follows.

### Production Example 1

### Samples of Tubes for Regenerating Pipelines

A mixture of LLDPE and EVA (ethylene-vinyl acetate copolymer) was employed as materials for the lower soft resin layer 5d. A mixture of SEBS and PP was employed as a material for the upper soft resin layer 5e. These mixtures were extruded to form strips respectively. There strips were spirally wound on an approximately cylindrical roller, in order, with each edge is overlapping, to form the lower soft resin layer 5d and the upper soft resin layer 5e, respectively. Herein, PPS was further employed as the hard resin. PPS was extruded in a form of a rod to form the core 5g. The rod has a certain height and width and a certain approximately rectangular cross-section. A wrapping of a resin material which is same as the material of the upper soft resin layer 5e was applied around the core 5g in order to form the coating 5f (thickness: about 1 mm) on the core. The resulting ridge 5c was spirally wound on the outer surface of the upper soft resin layer 5e (in other words, on the outer surface of the linear part 5b of the tube). Various tubes for the regeneration were prepared with varying the dimensions (e.g., height H and width W of the core 5g, pitch P, thickness of the linear part 5b of the tube, etc.) (see samples No. A1-1 to D2-2 in Tables 1-4, wherein the subscripts “−1” and “−2” represent other samples prepared under the same conditions).

Each of the prepared samples of the tube for the regeneration has a nominal diameter of 250 mm. Herein, the hard vinyl chloride pipe having the nominal diameter of 250 mm has a flattening strength of 4.61 kN/m.

According to the measured values on each sample, each of the ratios of the height H of the core, the width W of the core and the pitch P relative to the inner diameter Di; the area of the core (or a mathematical product of the height H of the core x the width W of the core); and each of the ratios of the width W of the core and the pitch P relative to the height H of the core were determined. Furthermore, the flattening strength of each sample was measured as follows. The results were shown in the following Tables 1 to 4.

### Flattening Strength

The flattening strength (or load resistance strength) (kN/m) of the tube for the regeneration was measured according to the “hard vinyl chloride pipe for sewerage (JSWAS K-1)” (which is Japan Sewage Works Association Standards).

TABLE 1

| | Sample of tube for regeneration | | | | | |
|---|---|---|---|---|---|---|
| | A1-1 | A1-2 | A2-1 | A2-2 | A3-1 | A3-2 |
| Height H of | 3.7 | 3.7 | 3.1 | 3.0 | 4.4 | 4.4 |
| core/Inner | | | | | | |
| diameter Di | | | | | | |
| (%) | | | | | | |
| Width W of | 4.3 | 4.5 | 4.7 | 4.6 | 5.3 | 5.1 |
| core/inner | | | | | | |
| diameter Di | | | | | | |
| (%) | | | | | | |
| Pitch P/Inner | 11.3 | 11.4 | 11.1 | 11.1 | 11.3 | 11.1 |
| diameter Di | | | | | | |
| (%) | | | | | | |
| Area of core | 74.4 | 78.1 | 66.6 | 64.1 | 108.6 | 104.8 |
| (mm²) | | | | | | |
| Width W of | 115 | 120 | 152 | 151 | 118 | 117 |
| core/Height of | | | | | | |
| core H (%) | | | | | | |
| Pitch P/Height | 304 | 306 | 361 | 368 | 253 | 253 |
| H of core (%) | | | | | | |
| Flattening | 5.68 | 5.82 | 3.12 | 3.21 | 9.78 | 10.08 |
| strength | | | | | | |
| (kN/m) | | | | | | |

TABLE 2

| | Sample of tube for regeneration | | | | | |
|---|---|---|---|---|---|---|
| | B1-1 | B1-2 | B2-1 | B2-2 | B3-1 | B3-2 |
| Height H of | 3.6 | 3.7 | 3.2 | 3.1 | 4.4 | 4.4 |
| core/Inner | | | | | | |
| diameter Di | | | | | | |
| (%) | | | | | | |
| Width W of | 4.5 | 4.4 | 5.3 | 4.1 | 5.3 | 5.5 |
| core/Inner | | | | | | |
| diameter Di | | | | | | |
| (%) | | | | | | |
| Pitch P/Inner | 10.8 | 10.8 | 10.5 | 10.6 | 10.5 | 10.7 |
| diameter Di | | | | | | |
| (%) | | | | | | |
| Area of core | 75.3 | 77.1 | 77.7 | 59.2 | 107.6 | 110.6 |
| (mm²) | | | | | | |
| Width W of | 123 | 118 | 167 | 131 | 121 | 124 |
| core/Height H | | | | | | |
| of core (%) | | | | | | |
| Pitch P/Height | 298 | 289 | 331 | 339 | 239 | 245 |
| H of core (%) | | | | | | |
| Flattening | 5.66 | 5.41 | 3.82 | 3.83 | 9.95 | 9.96 |
| strength | | | | | | |
| (kN/m) | | | | | | |

TABLE 3

| | Sample of tube for regeneration | | | | | |
|---|---|---|---|---|---|---|
| | C1-1 | C1-2 | C2-1 | C2-2 | C3-1 | C3-2 |
| Height H of | 3.6 | 3.4 | 3.3 | 3.3 | 4.3 | 4.5 |
| core/Inner | | | | | | |
| diameter Di | | | | | | |
| (%) | | | | | | |
| Width W of | 4.4 | 5.0 | 4.0 | 4.0 | 5.1 | 5.3 |
| core/Inner | | | | | | |
| diameter Di | | | | | | |
| (%) | | | | | | |
| Pitch P/Inner | 12.7 | 12.4 | 12.8 | 13.0 | 12.8 | 12.6 |
| diameter Di | | | | | | |
| (%) | | | | | | |
| Area of core | 74.9 | 79.4 | 60.5 | 61.1 | 102.6 | 111.4 |
| (mm²) | | | | | | |
| Width W of | 123 | 146 | 122 | 119 | 118 | 117 |
| core/Height H | | | | | | |
| of core (%) | | | | | | |
| Pitch P/Height | 352 | 363 | 391 | 391 | 296 | 279 |
| H of core | | | | | | |
| (%) | | | | | | |
| Flattening | 4.83 | 4.47 | 3.60 | 3.52 | 8.34 | 8.03 |
| strength | | | | | | |
| (kN/m) | | | | | | |

TABLE 4

| | Sample of tube for regeneration | | | |
|---|---|---|---|---|
| | D1-1 | D1-2 | D2-1 | D2-2 |
| Height H of core/ | 3.9 | 3.8 | 3.9 | 4.0 |
| Inner diameter Di (%) | | | | |
| Width W of core/ | 4.4 | 4.5 | 4.1 | 4.1 |
| Inner diameter Di (%) | | | | |
| Pitch P/Inner | 11.2 | 11.2 | 11.3 | 11.4 |
| diameter Di (%) | | | | |
| Area of core (mm²) | 79.8 | 78.6 | 75.7 | 75.7 |
| Width W of core/ | 113 | 120 | 105 | 102 |
| Height H of core (%) | | | | |
| Pitch P/Height | 288 | 298 | 286 | 285 |
| H of core (%) | | | | |
| Flattening | 5.70 | 5.68 | 6.42 | 6.21 |
| strength (kN/m) | | | | |

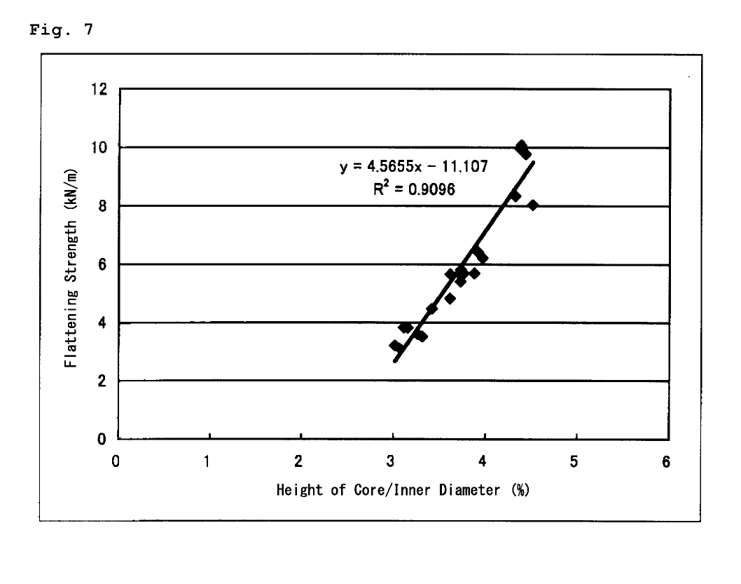

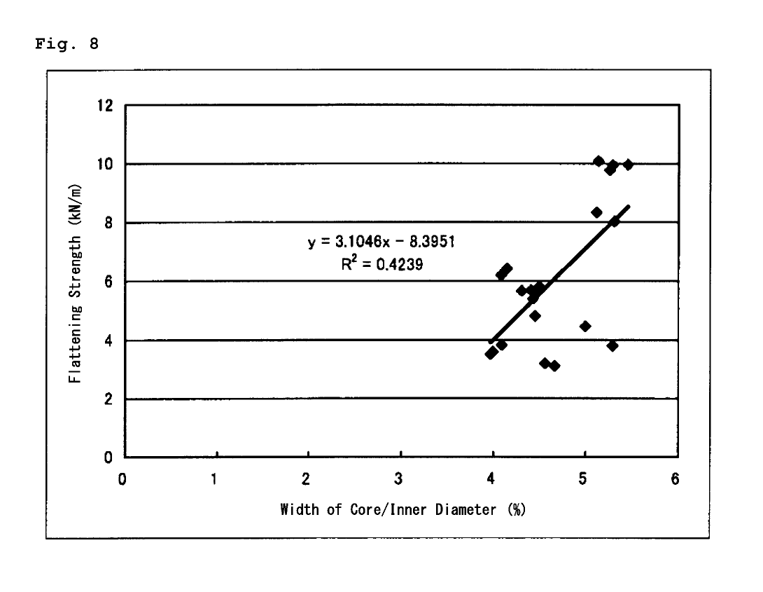

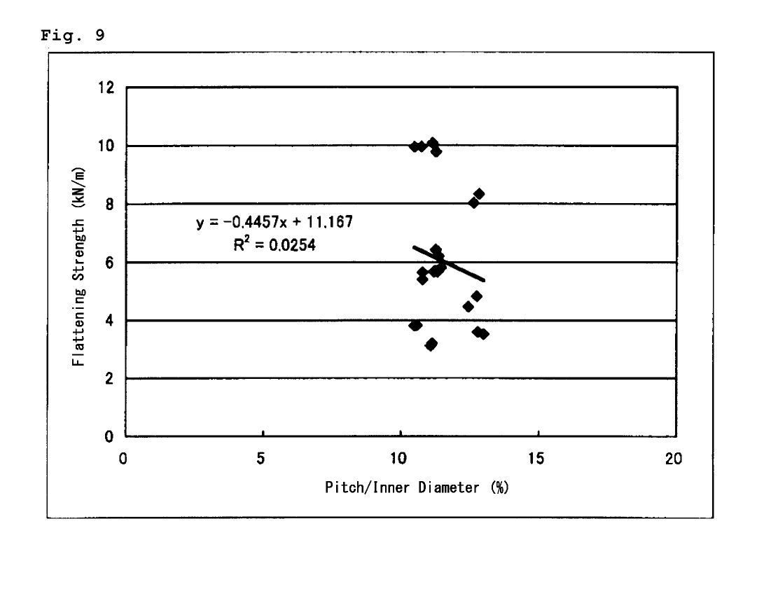

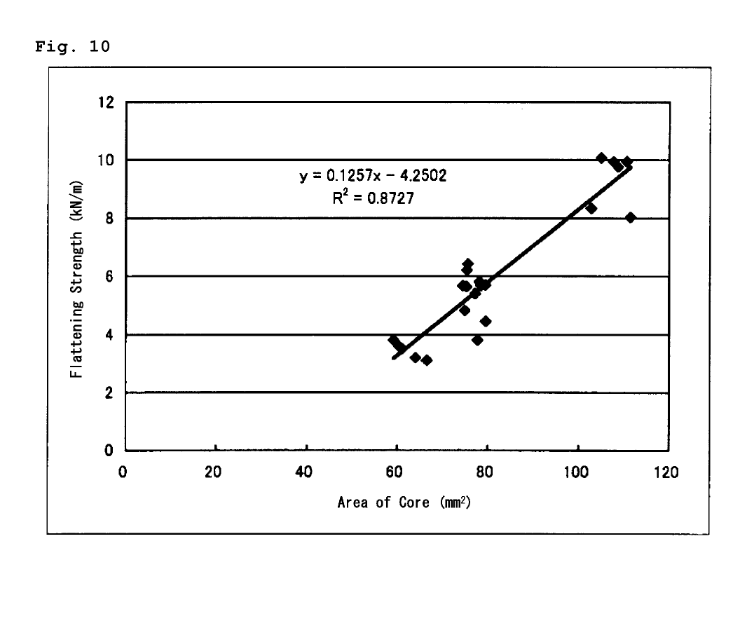

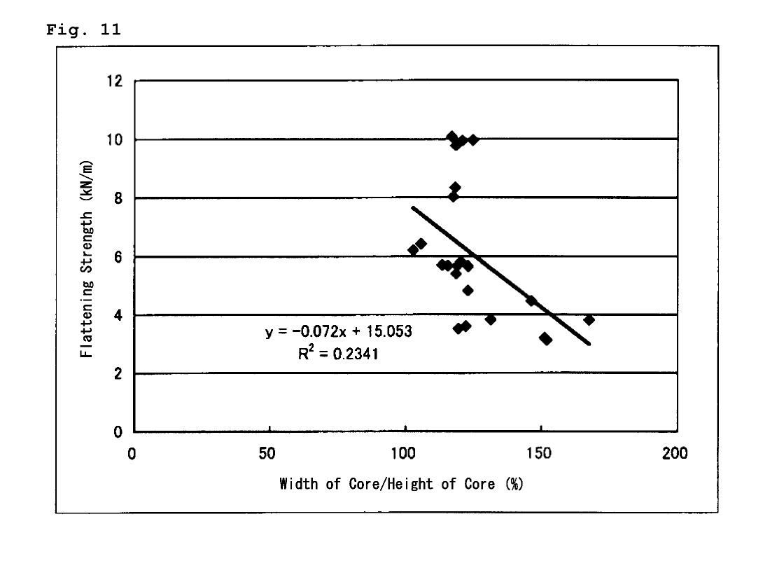

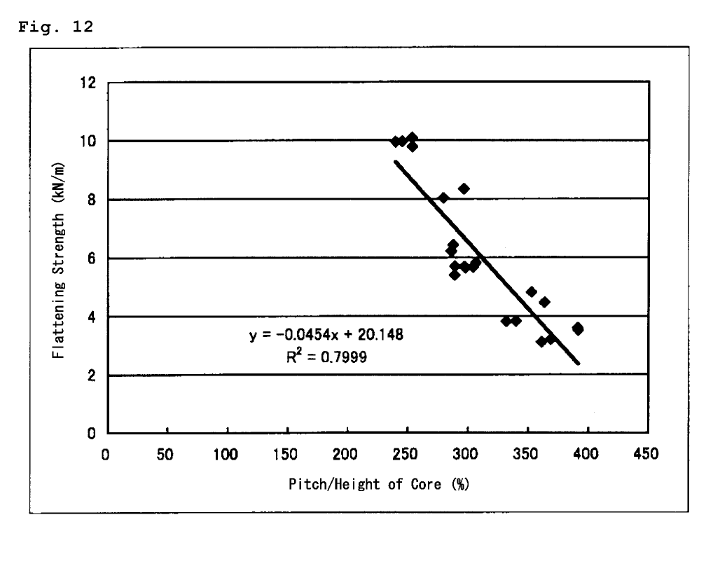

In order to specify the factor having a strong influence on the flattening strength, graphs of FIG. 7 to FIG. 12 were prepared based on the data of Tables 1 to 4. In these figures, a line by the linear approximation and the equation thereof as well as the correlation efficient thereof are additionally shown. As it can be seen in the FIG. 7, it is found that the flattening strength of the tube for the regeneration has an excellent correlation (with the correlation coefficient R²=0.90 or more) to the ratio of the height H of the core relative to the inner diameter Di of the linear part of the tube. Whereas, as it is can be seen from FIG. 8 to FIG. 12, other factors do not particularly provide any correlation to the flattening strength of the tube for the regeneration. These results suggests that an only appropriate selection on the ratio of the height H of the core relative to the inner diameter Di of the linear part of the tube can control the flattening strength of the tube for the regeneration rather than the particular other factors. It is understood from the results of FIG. 7 that the flattening strength same as, or more than, that of the hard vinyl chloride pipe can be provided (or a flattening strength which is 4.61 kN/m or more at the nominal diameter of 250 mm) in case of that the height H of the core is 3.5% or more of the inner diameter Di of the linear part of the tube.

Herein, each of the samples of the tube for the regeneration shown in Tables 1 to 4 contained the single layer part in the lower soft resin layer.

### Production Example 2

### Samples of Tubes for Regenerating Pipelines

Samples E to H of the tubes for the regeneration having nominal diameter of 250 mm were prepared according a method similar to the above-described method with the proviso that PPE was employed instead of the PPS. According to the measured values on each sample, each of the ratios of the height H of the core, the width W of the core and the pitch P relative to the inner diameter Di; the area of the core (or a mathematical product of the height H of the core x the width W of the core); and each of the ratios of the width W of the core and the pitch P relative to the height H of the core; and the ratio of the thickness T₂ₛ of the single layer part relative to the inner diameter Di were determined. Furthermore, the flattening strength of each sample was measured as described-above. The tensile strength of each sample was measured as follows. The results were shown in the following Table 5.

### Tensile Strength

The tensile strength (N/10 mm) was measured according to the “JIS K 7161”.

TABLE 5

| | Sample of tube for regeneration | | | |
|---|---|---|---|---|
| | E | F | G | H |
| Height H of core/ | 3.0 | 3.6 | 4.5 | 3.6 |
| Inner diameter Di (%) | | | | |
| Width W of core/ | 5.8 | 5.5 | 5.5 | 5.7 |
| Inner diameter Di (%) | | | | |
| Pitch P/Inner | 11.6 | 11.7 | 11.8 | 11.8 |
| diameter Di (%) | | | | |
| Area of core (mm²) | 79.8 | 91.5 | 112.0 | 94.2 |
| Width W of core/ | 195 | 154 | 124 | 159 |
| Height H of core (%) | | | | |
| Pitch P/Height | 389 | 326 | 264 | 330 |
| H of core (%) | | | | |
| Thickness T₂ₛ/Inner | 0.35 | 0.42 | 0.42 | 0.36 |
| diameter Di (%) | | | | |
| Flattening | 3.87 | 5.23 | 7.72 | 5.52 |
| strength (kN/m) | | | | |
| Tensile strength | 122.0 | 131.9 | 126.5 | 128.0 |
| (N/10 mm) | | | | |

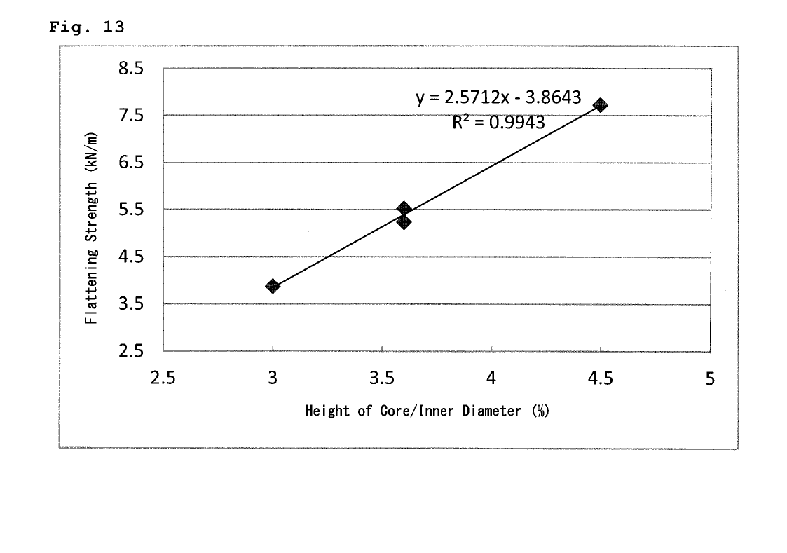

Even if the PPE was employed instead of the PPS, it is found that the flattening strength of the tube for the regeneration has an excellent correlation (with the correlation coefficient R²=0.99 or more) to the ratio (%) of the height H of the core relative to the inner diameter Di of the linear part of the tube (FIG. 13).

Therefore, according to the present invention, it is found that an only appropriate selection of the ratio of the height H of the core relative to the inner diameter Di of the linear part of the tube can control the flattening strength of the tube for the regeneration without any limitation by the material forming the core. Herein, other factors than the height of the core (e.g., the area of core and pitch) may not be specific.

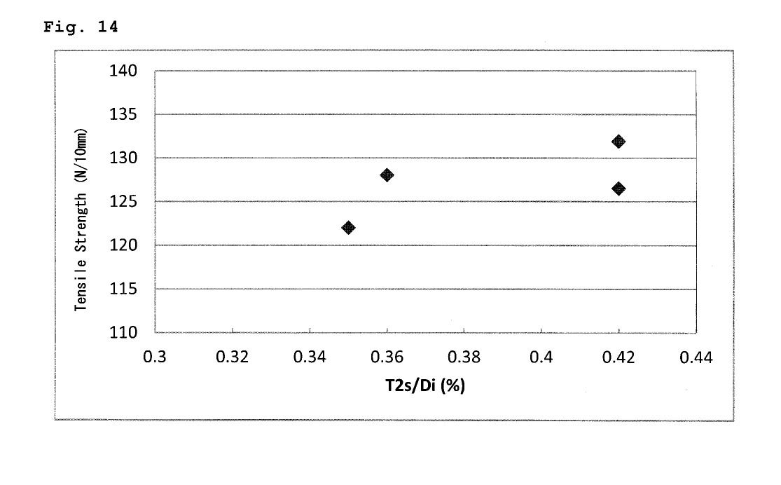

In addition, it is found that a greater ratio (%) of the thickness T₂ₛ of the single layer part relative to the inner diameter Di of the tube for the regeneration can provide a further improved tensile strength (FIG. 14).

### Production Example 3

### Samples of the Tubes for Regenerating Pipelines

Samples of the tubes for the regeneration having nominal diameter of 250 mm were prepared according to a similar method to the method described above with the proviso that the pitch P of the ridge 5c is 25 mm and the hard resin forming the core of the ridge was PPS. The ratio (%) of the thickness T₂ₛ of the single layer part of each sample relative to the inner diameter Di was determined. The tensile strength of each sample was measured as described above. The results are shown in the following Table 6.

TABLE 6

Sample of tube for regeneration

| | I-1 | J-1 | J-2 | J-3 |
|---|---|---|---|---|
| Tensile | 134.6 | 127.1 | 127.1 | 128.6 |
| strength | | | | |
| (N/10 mm) | | | | |
| Thickness T₂ₛ/ | 0.47 | 0.57 | 0.51 | 0.60 |
| Inner diameter | | | | |
| Di (%) | | | | |

| | Sample of tube for regeneration | | | | | |
|---|---|---|---|---|---|---|
| | K-1 | K-2 | K-3 | L-1 | L-2 | L-3 |
| Tensile | 146.0 | 149.3 | 143.8 | 132.3 | 174.1 | 160.8 |
| strength | | | | | | |
| (N/10 mm) | | | | | | |
| Thickness T₂ₛ/ | 0.46 | 0.45 | 0.51 | 0.59 | 0.53 | 0.64 |
| Inner diameter | | | | | | |
| Di (%) | | | | | | |
| | Sample of tube for regeneration | | | | | |
| | M-1 | M-2 | M-3 | N-1 | N-2 | N-3 |
| Tensile | 180.6 | 174.6 | 188.6 | 135.6 | 182.7 | 186.5 |
| strength | | | | | | |
| (N/10 mm) | | | | | | |
| Thickness T₂ₛ/ | 0.58 | 0.60 | 0.54 | 0.57 | 0.50 | 0.59 |
| Inner diameter | | | | | | |
| Di (%) | | | | | | |
| | Sample of tube for regeneration | | | | | |
| | O-1 | O-2 | O-3 | P-1 | P-2 | P-3 |
| Tensile | 177.2 | 166.0 | 195.3 | 207.0 | 195.0 | 210.5 |
| strength | | | | | | |
| (N/10 mm) | | | | | | |
| Thickness T₂ₛ/ | 0.62 | 0.56 | 0.63 | 0.66 | 0.71 | 0.66 |
| Inner diameter | | | | | | |
| Di (%) | | | | | | |

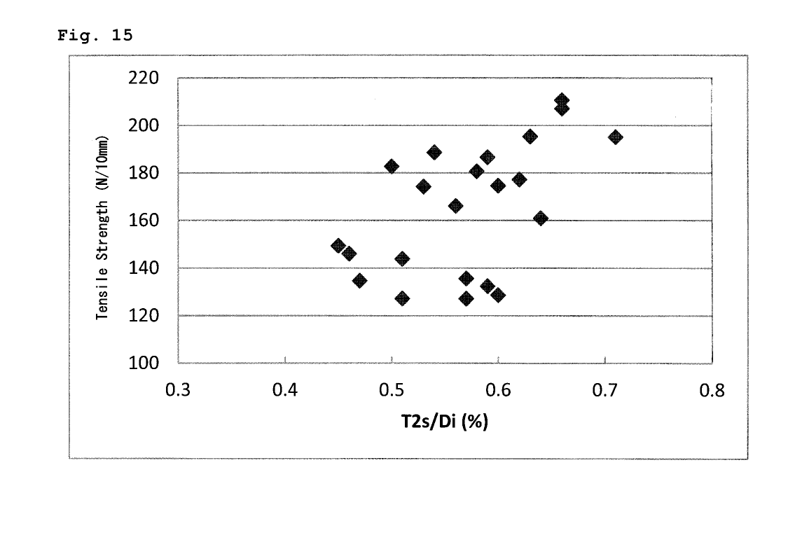

From the results shown above, it is found that a greater ratio (%) of the thickness T₂ₛ of the single layer part relative to the inner diameter Di of the tube for regeneration can provide further improved tensile strength (FIG. 15), which tendency in this Production Example 3 is similar to that of the Production Example 2.

### <90° Bending Test>

With respect to the samples of the tubes for the regeneration obtained in the Production Example 2 and the Production Example 3, the presence and absence of the tears occurring on the outer circumferential area of the curved area of the sample tube, which is curved at an angle of 90°, outside of the bend radius direction as well as the wrinkles occurring on the inner surface of the inner circumferential area (which is opposed to the outer circumferential area) of the sample tube in the bend radius direction are visually inspected.

As additional production examples, samples Q-1 to Q-5 of the tubes for the regeneration were prepared according to the similar method to that of the Production Example 2. During the sample tubes are curved at 90°, the presence or absence of the tears occurring on the outer circumferential area of the curved area and the wrinkles occurring on the inner surface of the inner circumferential area of the sample tubes are visually inspected.

Absence of any tears or wrinkles on the sample of the tube for the regeneration which is curved at an angle of 90° is evaluated as “successful”.

Presence of the tear(s) occurred on the outer circumferential area of the curved area of the sample of the tube for the regeneration which is curved at an angle of 90° is evaluated as “teared”.

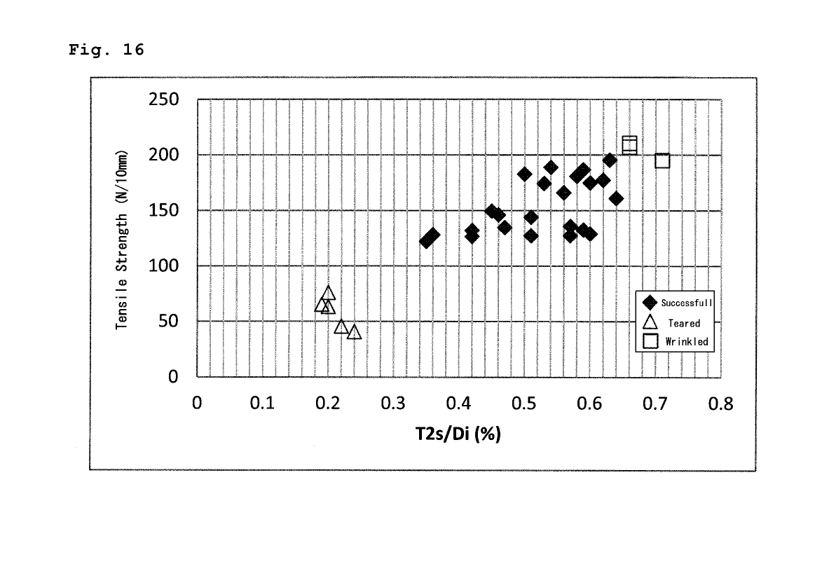

Presence of the protruding wrinkle(s) occurred on the inner surface of the inner circumferential area of the sample of the tube for the regeneration is evaluated as “wrinkled”. The results are shown in the following Tables 7 and 8 and FIG. 16.

In FIG. 16, the evaluation as the “successful” is indicated in a symbol of black diamond. The evaluation as the “teared” is indicated in a symbol of white triangle. The evaluation as the “wrinkled” is indicated in a symbol of white square.

TABLE 7
Samples of the tubes for the regeneration according to Production
Example 2 (Core: PPE, and Nominal diameter: 250 mm)

| | Sample of tube for regeneration | | | |
|---|---|---|---|---|
| | E | F | G | H |
| 90° bending test | Successful | Successful | Successful | Successful |

| | Sample of tube for regeneration | | | | |
|---|---|---|---|---|---|
| | Q-1 | Q-2 | Q-3 | Q-4 | Q-5 |
| Tensile strength | 45.6 | 76.0 | 40.7 | 65.3 | 63.2 |
| (N/10 mm) | | | | | |
| Thickness T₂ₛ/Inner | 0.22 | 0.20 | 0.24 | 0.19 | 0.20 |
| diameter Di (%) | | | | | |
| 90° bending test | Teared | Teared | Teared | Teared | Teared |

TABLE 8
Samples of the tube for the regeneration according to Production Example 3
(Core: PPS, and Nominal diameter: 250 mm)

| | Sample of tube for regeneration | | | |
|---|---|---|---|---|
| | I-1 | J-1 | J-2 | J-3 |
| 90° bending test | Successful | Successful | Successful | Successful |

| | Sample of tube for regeneration | | | | | |
|---|---|---|---|---|---|---|
| | K-1 | K-2 | K-3 | L-1 | L-2 | L-3 |
| 90° bending test | Successful | Successful | Successful | Successful | Successful | Successful |
| | Sample of tube for regeneration | | | | | |
| | M-1 | M-2 | M-3 | N-1 | N-2 | N-3 |
| 90° bending test | Successful | Successful | Successful | Successful | Successful | Successful |
| | Sample of tube for regeneration | | | | | |
| | O-1 | O-2 | O-3 | P-1 | P-2 | P-3 |
| 90° bending test | Successful | Successful | Successful | Wrinkled | Wrinkled | Wrinkled |

As shown in FIG. 16, according to the additional samples Q-1 to Q-5 of the Production Example 2, the ratio (T₂ₛ/Di (%)) of the thickness T₂ₛ of the single layer part relative to the inner diameter Di is 0.25% or less. At that time, it is found that the tensile strength is significantly decreased, and the tears occurs on the tube for the regeneration. It is also found that, with respect to the samples P-1 to P-3 of the Production Example 3, in case of the ratio of T₂ₛ/Di is excess over 0.65%, the wrinkles occurs on the tube for the regeneration (see FIG. 16).

According to the results described above, it is found that each of the tubes for the regeneration which are evaluated as “successful” has the ratio of T₂ₛ/Di within a range of from 0.25% to 0.65%, and a tensile strength of no less than 100 N/10 mm (see FIG. 16).

Accordingly, the present invention can significantly inhibit the tears and wrinkles which may occur during the drawing of the tube for the regeneration, which is surprisingly by setting the ratio of T₂ₛ/Di within a range of from 0.25% to 0.65%.

The present application claims the priority based on the Japanese Patent Application No. 2012-231044 filed on Oct. 18, 2012 in Japan, which disclosure is incorporated herein by reference in its entirety.

### INDUSTRIAL APPLICABILITY

The present inventive tube for regenerating a pipeline is available for regenerating the existing pipes such as drainage pipes which had been embedded under the ground, etc.

Explanations of Letters or Numerals
1: Drainage pipe
2: Left side manhole
2a: Aperture
2b: Upper opening
3: Right side manhole
3a: Aperture
3b: Upper opening
4: Water-stopping plug
5: Tube for regeneration
5a: Progressing terminal
5b: Linear part of tube
5c: Ridge
5d: Lower soft resin layer
5ds: Single layer part of lower soft resin layer
5dm₀, 5dm₁, 5dm₂, 5dm₃: Overlapping part of lower soft resin layer
5e: Upper soft resin layer
5es: Upper soft resin layer placed on upper side of single layer part of lower soft resin layer
5f: Coating for core
5g: Core made of hard resin
6: Rotary drum
11: Roll
12: Die
13: Lip
14: Soft resin strip for inner layer
15: Die
16: Lip
17: Soft resin strip for outer layer
H: Height (of core)
W: Width (of core)
P: Pitch
Do: Outer diameter
Di: Inner diameter

Ds: Width (of single layer part of lower soft resin layer)
Dm₁, Dm₂: Width (of overlapping part of lower soft resin layer)
Dw: Width (of processed strip)
T₁: Thickness (of upper soft resin layer)
T₁ₛ: Thickness (of upper soft resin layer placed on upper side of single layer part)
T₂: Thickness (of lower soft resin layer)
T₂ₛ: Thickness (of single layer part of lower soft resin layer)
T: Thickness (of linear part of tube)

1. A tube for regenerating a pipeline, which comprises
a lower soft resin layer, which is an inner layer of a linear part of the tube,
an upper soft resin layer formed on an outside of the lower soft resin layer, which is an outer layer of the linear part of the tube, and
a ridge spirally formed on an outer surface of the upper soft resin layer,
wherein the tube is characterized in that
the ridge is formed from a core made of a hard resin being spirally wound, and a coating for the core, wherein the coating is integrated with the upper soft resin layer while the core is wrapped up in the coating,
the core has a height which is 3.5% to 5% of an inner diameter of the linear part of the tube,
the lower soft resin layer is formed by spiral winding to comprise at least a single layer part,
the single layer part has a thickness which is 0.25% to 0.65% of the inner diameter of the linear part of the tube.

2. The tube for regenerating a pipeline according to claim 1, wherein the core has a width which is 80 to 200% of a height of the core.

3. The tube for regenerating a pipeline according to claim 1, wherein the ridge has a spiral pitch which is 150 to 350% of a height of the core.

4. The tube for regenerating a pipeline according to claim 1, wherein the linear part of the tube has a thickness which is 0.7 to 1.5% of the inner diameter of the linear part of the tube.

5. The tube for regenerating a pipeline according to claim 1, wherein the core is formed from an engineering plastic.

6. The tube for regenerating a pipeline according to claim 1, wherein the core is formed from any one of PPS (polyphenylene sulfide), PPE (polyphenylene ether), PEI (polyether imide), PAR (polyarylate), PES (polyether sulfone), PEEK (polyetheretherketone), PTFE (polytetrafluoroethylene), PET (polyethylene terephthalate), PBT (polybutylene terephthalate), PA (polyamide), POM (polyacetal) and a polymer blend thereof.

7. The tube for regenerating a pipeline according to claim 6, wherein the core is formed from PPS or PPE.

8. The tube for regenerating a pipeline according to claim 1, the core comprises a glass fiber.

9. The tube for regenerating a pipeline according to claim 1, wherein the lower soft resin layer comprises at least one selected from the group consisting of a linear low density polyethylene, other low density polyethylene and a medium density polyethylene.

10. The tube for regenerating a pipeline according to claim 1, wherein the upper soft resin layer comprises a thermoplastic elastomer blended with an olefin-based resin.

11. The tube for regenerating a pipeline according to claim 1, wherein the coating for the core is formed from the same material as that of the upper soft resin layer.
